(19) United States
(12) Patent Application Publication
(10) Pub. No.: US 2013/0020740 A1
(43) Pub. Date: Jan. 24, 2013

(54) Molding Apparatus Including Source Providing Electrical Charge to Conduit

(71) Applicants: Edward Joseph Jenko, Essex, VT (US); Angelo Mier, Colchester, VT (US)

(72) Inventors: Edward Joseph Jenko, Essex, VT (US); Angelo Mier, Colchester, VT (US)

(73) Assignee: HUSKY INJECTION MOLDING SYSTEMS LTD., Bolton, ON (CA)

(21) Appl. No.: 13/639,516

(22) PCT Filed: Mar. 23, 2011
(86) PCT No.: PCT/US11/29493

§ 371 Date: Oct. 8, 2012

Related U.S. Application Data
(60) Provisional application No. 61/320,782, filed on Apr. 5, 2010.

(51) Int. Cl. B29C 35/08

(52) U.S. Cl. 264/404; 425/174

(57) ABSTRACT

The present invention relates to a molding system (100) including (but not limited to): (i) an electrically chargeable conduit (102), and (ii) an electrical-charge source (104) configured to provide an electrical charge to the electrically-chargeable conduit (102), the electrical charge hastening flow of a resin (106) along the electrically-chargeable conduit (102).

### TECHNICAL FIELD

An aspect of the present invention generally relates to (but is not limited to) a molding apparatus including (but not limited to) an electrical-charge source to provide an electrical charge to an electrically-chargeable conduit.

### BACKGROUND

The first man-made plastic was invented in Britain in 1851 by Alexander PARKES. He publicly demonstrated it at the 1862 International Exhibition in London, calling the material Parkesine. Derived from cellulose, Parkesine could be heated, molded, and retain its shape when cooled. It was, however, expensive to produce, prone to cracking, and highly flammable. In 1868, American inventor John Wesley HYATT developed a plastic material he named Celluloid, improving on PARKES' invention so that it could be processed into finished form. HYATT patented the first injection molding machine in 1872. It worked like a large hypodermic needle, using a plunger to inject plastic through a heated cylinder into a mold. The industry expanded rapidly in the 1940s because World War II created a huge demand for inexpensive, mass-produced products. In 1946, American inventor James Watson HENDRY built the first screw injection machine. This machine also allowed material to be mixed before injection, so that colored or recycled plastic could be added to virgin material and mixed thoroughly before being injected. In the 1970s, HENDRY went on to develop the first gas-assisted injection molding process.

Injection molding machines consist of a material hopper, an injection ram or screw-type plunger, and a heating unit. They are also known as presses, they hold the molds in which the components are shaped. Presses are rated by tonnage, which expresses the amount of clamping force that the machine can exert. This force keeps the mold closed during the injection process. Tonnage can vary from less than five tons to 6000 tons, with the higher figures used in comparatively few manufacturing operations. The total clamp force needed is determined by the projected area of the part being molded. This projected area is multiplied by a clamp force of from two to eight tons for each square inch of the projected areas. As a rule of thumb, four or five tons per square inch can be used for most products. If the plastic material is very stiff, it will require more injection pressure to fill the mold, thus more clamp tonnage to hold the mold closed. The required force can also be determined by the material used and the size of the part, larger parts require higher clamping force. With Injection Molding, granular plastic is fed by gravity from a hopper into a heated barrel. As the granules are slowly moved forward by a screw-type plunger, the plastic is forced into a heated chamber, where it is melted. As the plunger advances, the melted plastic is forced through a nozzle that rests against the mold, allowing it to enter the mold cavity through a gate and runner system. The mold remains cold so the plastic solidifies almost as soon as the mold is filled. Mold assembly or die are terms used to describe the tooling used to produce plastic parts in molding. The mold assembly is used in mass production where thousands of parts are produced. Molds are typically constructed from hardened steel, etc. Hot-runner systems are used in molding systems, along with mold assemblies, for the manufacture of plastic articles. Usually, hot-runners systems and mold assemblies are treated as tools that may be sold and supplied separately from molding systems.

United States Patent No. US 2002/110612 discloses an injection molding system for the formation of molded articles with reduced crystallinity including a laser cutoff subsystem for the removal of an elongated vestige or sprue from the molded article.

United States Patent No. US 2005/248057 discloses a method of manufacturing a molded article with a mold having an inner surface is provided. The method includes the steps of applying a substance to the inner surface of the mold, introducing a thermoplastic resin into the mold and onto the substance, defining a molded article having a surface, and maintaining contact of the thermoplastic resin and the substance for a predetermined time period. The thermoplastic resin has a predetermined heated energy and at least a portion of the heat energy is transferred to the substance. During the predetermined time period, the substance diffuses through at least a portion of the surface of the molded article

### SUMMARY

The inventors have researched a problem associated with known molding systems that inadvertently manufacture bad-quality molded articles or parts. After much study, the inventors believe they have arrived at an understanding of the problem and its solution, which are stated below, and the inventors believe this understanding is not known to the public.

Molten plastics have varying tendencies to stick to metals (conduits) or move slowly across metals or other metal surfaces, such as those used in equipment for the processing and forming of plastic articles (such as molding systems). Some plastics also have a tendency to adhere to metals or other material surfaces when they are in the solidified state.

With regard to a molten plastic (sometimes called a resin), as a result of the slow movement or adherence to the surface that plastic comes in contact with, the plastic experiences a longer time at the processing temperature than the bulk of the plastic flowing through the known molding system. The longer plastic is exposed to elevated temperatures, the more thermal degradation it experiences and as the degraded material enters the mold cavity it will have a negative impact on the physical or visual properties of the final molded part.

Also, for molding systems needing to mold part of different colors, periodic color changes are necessary. Slow moving or stagnant molten plastic on the equipment surfaces disadvantageously increases the time and amount of material required to flush the existing plastic from the molding system, before making molded articles without the appearance of the previous color in visual evidence.

To solve the above identified problems, the inventor has found a way to hasten movement of a resin along a conduit in the molding system. According to one aspect of the solution, there is provided a molding apparatus (100), comprising: an electrically-chargeable conduit (102), and an electrical-charge source (104) being configured to provide an electrical charge to the electrically-chargeable conduit (102), in which the electrical charge hastening the flow of a resin (106) along the electrically-chargeable conduit (102).

According to another aspect, there is provided a method of operating a molding system (100), the method comprising: providing an electrical charge and electrically-chargeable conduit (102), the electrical charge hastening flow of a resin (106) along the electrically-chargeable conduit (102).

Other aspects and features of the non-limiting embodiments will now become apparent to those skilled in the art upon review of the following detailed description of the non-limiting embodiments with the accompanying drawings.

### DETAILED DESCRIPTION OF THE DRAWINGS

The non-limiting embodiments will be more fully appreciated by reference to the following detailed description of the non-limiting embodiments when taken in conjunction with the accompanying drawings, in which:

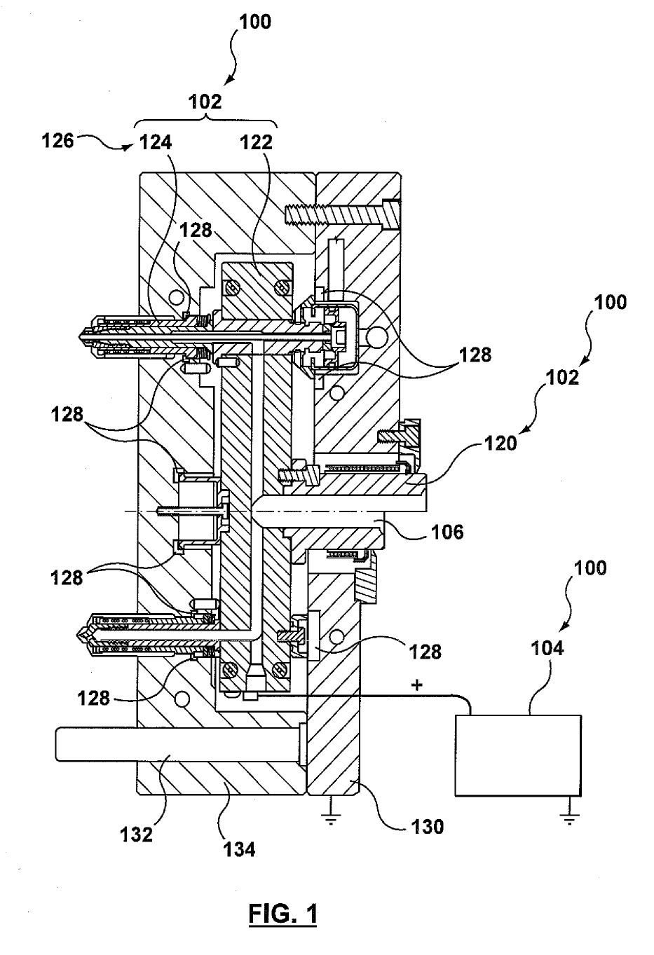

FIG. 1 depicts a schematic representation of a molding system (100).

The drawings are not necessarily to scale and may be illustrated by phantom lines, diagrammatic representations and fragmentary views. In certain instances, details not necessary for an understanding of the embodiments (and/or details that render other details difficult to perceive) may have been omitted.

### DETAILED DESCRIPTION OF THE NON-LIMITING EMBODIMENT(S)

FIG. 1 depicts the schematic representation of the molding system (100). The molding system (100) may include components that are known to persons skilled in the art, and these known components will not be described here; these known components are described, at least in part, in the following reference books (for example): (i) “Injection Molding Handbook” authored by OSSWALD/TURNG/GRAMANN (ISBN: 3-446-21669-2), (ii) “Injection Molding Handbook” authored by ROSATO AND ROSATO (ISBN: 0-412-99381-3), (iii) “Injection Molding Systems” 3^{rd} Edition authored by JOHANNABER (ISBN 3-446-17733-7) and/or (iv) “Runner and Gating Design Handbook” authored by BEAUMONT (ISBN 1-446-22672-9). It will be appreciated that for the purposes of this document, the phrase “includes (but is not limited to)” is equivalent to the word “comprising”. The word “comprising” is a transitional phrase or word that links the preamble of a patent claim to the specific elements set forth in the claim which define what the invention itself actually is. The transitional phrase acts as a limitation on the claim, indicating whether a similar device, method, or composition infringes the patent if the accused device (etc) contains more or fewer elements than the claim in the patent. The word “comprising” is to be treated as an open transition, which is the broadest form of transition, as it does not limit the preamble to whatever elements are identified in the claim.

The molding system (100) includes (but is not limited to): (i) an electrically-chargeable conduit (102), and (ii) an electrical-charge source (104). The electrical-charge source (104) is configured to provide an electrical charge to the electrically-chargeable conduit (102). The electrical charge hastens flow of a resin (106) along the electrically-chargeable conduit (102). It will be appreciated that a method of operating a molding system (100) may be used. The method includes (but is not limited to) providing an electrical charge to an electrically-chargeable conduit (102), the electrical charge hastening flow of a resin (106) along the electrically-chargeable conduit (102). The electrical-charge source (104) may be, for example, a high-voltage source providing (for example) 10,000 volts. Other types of electrical-charge sources may be used as well.

An electrical charge is applied to the surfaces or the components that touch the resin (106). The electrical charge that is applied to the electrically-chargeable conduit (102) may be positive or may be negative depending on the composition of the resin (106) such that the electrical charge improves the movement (faster movement) of the resin (106) along the inner surface (passageway) of the electrically-chargeable conduit (102). The resin (106) is pulled along the electrically-charged surface of the electrically-chargeable conduit (102) more easily. Optionally, a small amount of a charge-compatible material may be added to the resin (106) such that the resin (106) may have a stronger influence (attraction) from the electrical charge. The charge-compatible material acts as a movement enhancer to the resin (106). The charge-compatible material may be applied as a constant additive (for continual movement performance) or intermittently at times to enhance the movement on a periodic basis.

Examples of the electrically-chargeable conduit (102) may include, but is not limited to: a sprue (120), a manifold assembly (122), a nozzle assembly (124), all used in a hot-runner assembly (126). An electrical insulator (128) may be used to electrically insulate the electrically-chargeable conduit (102). The hot-runner assembly (126) also includes other components such as a stationary plate (130), a guidance pin (132), and a manifold support plate (134).

For example, to create a positive charge in the melt channel of the manifold assembly (122), a high-voltage source (such as 10,000 volts or higher) may be connected by a power cable to the manifold assembly (122), and the manifold assembly (122) is (preferably) electrically isolated from ground. The surrounding plates (130, 134) are connected to a common ground.

In operation, the resin (106) is repelled by the positive charge being placed on the melt channel of the electrically-chargeable conduit (102). The resin (106) does not adhere as much to the melt channel, in comparison with a known hot-runner system. The result is that the resin (106) along the electrically-chargeable conduit (102) may have a shorter residence time at an elevated temperature, thereby exhibiting less degradation of mechanical properties of the resin (106). Also, in the case of color-change duration (that is, when the color of the resin (106) is being changed), the time required to move from one color to the next may be advantageously reduced.

Different resins may respond better to specific voltage potentials or to different polarity of the charge being applied to the electrically-chargeable conduit (102). Pre-conditioning the resin (106) with an electrical charge may help in further hastening the movement of the resin (106) along the electrically-chargeable conduit (102). Doping the resin (106) with an electrically-charged sensitive element is also an option, so as to assist the resin (106) to move more freely (that is, with less resistance). The additive (the doping element) may be mixed with a feedstock in a feed throat of a plastication unit (sometimes called an extruder). Alternatively, the entire hot runner system (126) may be grounded and the resin (106) and the additive may be given a positive charge, creating the same surface slip benefit.

It is understood that the scope of the present invention is limited to the scope provided by the independent claims, and it is also understood that the scope of the present invention is not limited to: (i) the dependent claims, (ii) the detailed description of the non-limiting embodiments, (iii) the summary, (iv) the abstract, and/or (v) description provided outside of this document (that is, outside of the instant application as filed, as prosecuted, and/or as granted). It is understood, for the purposes of this document, the phrase “includes (but is not limited to)” is equivalent to the word “comprising”. The word “comprising” is a transitional phrase or word that links the preamble of a patent claim to the specific elements set forth in the claim which define what the invention itself actually is. The transitional phrase acts as a limitation on the claim, indicating whether a similar device, method, or composition infringes the patent if the accused device (etc) contains more or fewer elements than the claim in the patent. The word “comprising” is to be treated as an open transition, which is the broadest form of transition, as it does not limit the preamble to whatever elements are identified in the claim. It is noted that the foregoing has outlined the non-limiting embodiments. Thus, although the description is made for particular non-limiting embodiments, the scope of the present invention is suitable and applicable to other arrangements and applications. Modifications to the non-limiting embodiments can be effected without departing from the scope of the independent claims. It is understood that the non-limiting embodiments are merely illustrative.

What is claimed is:

1. A molding system (100), comprising:
an electrically-chargeable conduit (102); and
an electrical-charge source (104) being configured to provide an electrical charge to the electrically-chargeable conduit (102), the electrical charge hastening flow of a resin (106) along the electrically-chargeable conduit (102).

2. The molding system (100) of claim 1, wherein:
the electrically-chargeable conduit (102) includes a sprue (120) of a hot-runner assembly (126).

3. The molding system (100) of claim 1, wherein:
the electrically-chargeable conduit (102) includes a manifold assembly (122) of a hot-runner assembly (126).

4. The molding system (100) of claim 1, wherein:
the electrically-chargeable conduit (102) includes a nozzle assembly (124) of a hot-runner assembly (126).

5. The molding system (100) of claim 1, further comprising:
an electrical insulator (128) for electrically insulating the electrically-chargeable conduit (102).

6. The molding system (100) of claim 1, wherein:
the electrical-charge source (104) includes a high-voltage source.

7. The molding system (100) of claim 1, wherein:
the electrical-charge source (104) includes a high-voltage source being connected with a manifold assembly (122) of a hot-runner assembly (126).

8. A method of operating a molding system (100), the method comprising:
providing an electrical charge to an electrically-chargeable conduit (102), the electrical charge hastening flow of a resin (106) along the electrically-chargeable conduit (102).
